(19) United States
(12) Patent Application Publication
(10) Pub. No.: US 2021/0367957 A1
(43) Pub. Date: Nov. 25, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventor: Yasuyuki FURUKAWA, Kanagawa (JP)

(73) Assignee: FUJIFILM Business Innovation Corp., Tokyo (JP)

(21) Appl. No.: 17/120,236

(22) Filed: Dec. 13, 2020

(30) Foreign Application Priority Data
May 25, 2020 (JP) 2020-090226

(51) Int. Cl. H04L 29/06; G06N 20/00; G06N 5/04

(52) U.S. Cl. CPC H04L 63/1416; H04L 63/1425; G06K 9/6259; G06N 5/04; G06N 20/00

(57) ABSTRACT

An information processing apparatus includes a processor configured to judge whether access from a subject terminal to a subject host is insecure communication based on: a degree of threat of the subject host, the degree of threat of the subject host being obtained as a result of inputting information indicating the subject host into a first learning unit, the first learning unit having performed first learning by using learning data so as to learn to output a degree of threat of a host in response to inputting of information indicating the host, information indicating a host and whether the host is a threat being used as the learning data; and a degree of abnormality of access from the subject terminal, the degree of abnormality of access from the subject terminal being obtained as a result of inputting a communication history of the subject terminal into a second learning unit, the second learning unit having performed second learning by using a communication history of a terminal as learning data so as to learn to output a degree of abnormality of access from the terminal.

### CROSS-REFERENCE TO RELATED APPLICATIONS

This application is based on and claims priority under 35 USC 119 from Japanese Patent Application No. 2020-090226 filed May 25, 2020.

### BACKGROUND

### (i) Technical Field

The present disclosure relates to an information processing apparatus and a non-transitory computer readable medium.

### (ii) Related Art

Hitherto, when a terminal accesses a host via a communication network, such as the Internet, making a judgement as to whether the host is a threat has been proposed. A host being a threat means that a host causes or may cause damage to a terminal, such as sending malware, which is a portmanteau word of “malicious” and “software”, to the terminal.

For example, Japanese Patent No. 6196008 discloses a device for calculating the degree of threat (degree of maliciousness) of a target communication partner. Communication partners which are already known whether they are a malicious communication partner or a benign communication partner are input as known communication partners. Based on a time change regarding in which manner a target communication partner is posted in a list of benign communication partners or a list of malicious communication partners over time and that regarding in which manner each of the known communication partners is posted in these lists, feature information concerning the target communication partner and that concerning each of the known communication partners are extracted. Based on these items of feature information, the degree of maliciousness of the target communication partner is calculated. Japanese Patent No. 5961183 discloses a method for detecting whether a host, which is accessed from a terminal, is a threat, by factoring in context information, such as an infection history of the terminal regarding whether the terminal has been infected with malware, for example.

A terminal infected with malware may involuntarily access various hosts against the will of the user of the terminal. In view of this, a technology for detecting whether a terminal accessing a host is infected with malware has been proposed.

As an example of the technology, Japanese Unexamined Patent Application Publication No. 2018-133004 discloses the following abnormality detection system. This system detects whether an Internet of things (IoT) terminal which makes access to a host is infected with malware, based on the feature, such as the frequency of communication between the IoT terminal and hosts or the number of types of hosts. As another example of the above-described technology, Japanese Patent No. 6078179 discloses the following security threat detection system. In this system, a learning machine learns the patterns of security attack access based on header information concerning a security attack packet (malicious packet) transmitted on a network, thereby detecting a security attack packet.

Both of access to a host which is a threat and access from a terminal infected with malware are communication which may cause damage to the terminal or the user of the terminal. In the specification, both of communication between a terminal (regardless of whether the terminal is infected with malware) and a host which is a threat and communication between a terminal infected with malware and a host (regardless of whether the host is a threat) will be called “insecure communication”.

### SUMMARY

In the related art, a device which judges whether a host is a threat makes this judgement whether a host known to the device is a threat. In other words, the device already knows the domain name or the Internet protocol (IP) address of a host and then judges whether this host is a threat. It is however difficult for such a device to determine whether a host unknown to the device is a threat.

It is possible that a terminal infected with malware connect to various types of hosts in various communication modes. It is thus difficult to define in advance what types of hosts are accessed by a terminal infected with malware and in which communication modes hosts are accessed. It is also difficult to cause a learning machine to learn such communication modes. It may thus be hard to judge based on the communication mode of a terminal whether access from this terminal is that from a terminal infected with malware.

As discussed above, it is difficult to detect whether an unknown host is a threat and also to determine whether access from a terminal is that from a terminal infected with malware. This makes it hard to judge whether access from a terminal to an unknown host is insecure communication.

Aspects of non-limiting embodiments of the present disclosure relate to making a judgement as to whether access from a terminal to an unknown host is insecure communication.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to judge whether access from a subject terminal to a subject host is insecure communication based on: a degree of threat of the subject host, the degree of threat of the subject host being obtained as a result of inputting information indicating the subject host into a first learning unit, the first learning unit having performed first learning by using learning data so as to learn to output a degree of threat of a host in response to inputting of information indicating the host, information indicating a host and whether the host is a threat being used as the learning data; and a degree of abnormality of access from the subject terminal, the degree of abnormality of access from the subject terminal being obtained as a result of inputting a communication history of the subject terminal into a second learning unit, the second learning unit having performed second learning by using a communication history of a terminal as learning data so as to learn to output a degree of abnormality of access from the terminal.

### BRIEF DESCRIPTION OF THE DRAWINGS

An exemplary embodiment of the present disclosure will be described in detail based on the following figures, wherein:

FIG. 1 is a block diagram illustrating a network system according to the exemplary embodiment;

FIG. 2 illustrates an example of a query log;

FIG. 3 illustrates an example of a communication log;

FIG. 4 is a block diagram illustrating a security server according to the exemplary embodiment;

FIG. 5 illustrates a first example of threshold association information;

FIG. 6 illustrates a first example of cache data;

FIG. 7 illustrates a second example of cache data;

FIG. 8 is a conceptual diagram illustrating learning processing executed by a first learning unit;

FIG. 9 illustrates a first example of the structure of a second learning unit;

FIG. 10 illustrates an example of a query type sequence by the terminal;

FIG. 11 illustrates a first example of learning input data and evaluation data in a query type sequence;

FIG. 12 illustrates a second example of learning input data and evaluation data in the query type sequence;

FIG. 13 illustrates a second example of the structure of the second learning unit;

FIG. 14 illustrates a first example of processing executed by a degree-of-abnormality obtainer;

FIG. 15 illustrates a second example of processing executed by the degree-of-abnormality obtainer; and

FIG. 16 illustrates a second example of the threshold association information.

### DETAILED DESCRIPTION

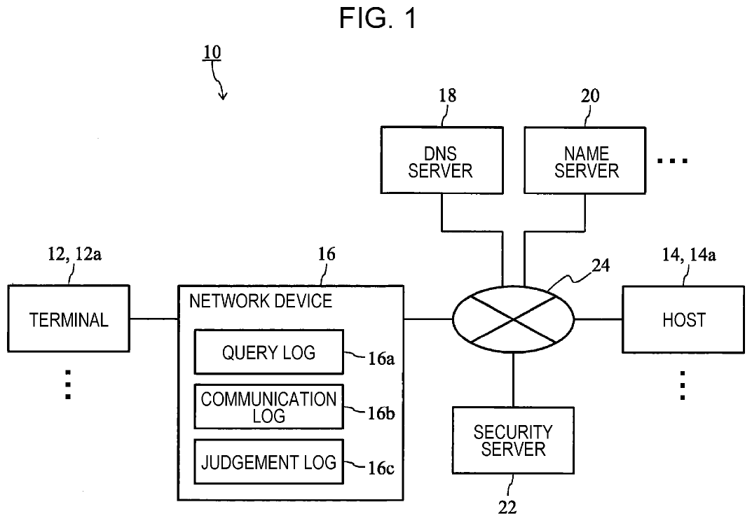

FIG. 1 is a block diagram illustrating a network system 10 according to an exemplary embodiment of the disclosure. The network system 10 includes one or plural terminals 12, one or plural hosts 14, a network device 16, a domain name system (DNS) server 18, one or plural name servers 20, and a security server 22, which serves as an information processing apparatus according to an exemplary embodiment of the disclosure. Hereinafter, an explanation will be given, assuming that plural terminals 12, plural hosts 14, and plural name servers 20 are provided in the network system 10. The terminals 12 and the network device 16 are connected with each other via an intranet, such as a local area network (LAN), so that they can communicate with each other. The hosts 14, the network device 16, the DNS server 18, the name servers 20, and the security server 22 are connected with each other via a communication network 24, such as the Internet and a LAN, so that they can communicate with each other.

The terminals 12 are personal computers (PCs), for example, and are used by corresponding users. The terminals 12 may be mobile terminals, such as tablet terminals. Each terminal 12 includes a communication interface, memory devices, such as a hard disk, a read only memory (ROM), and a random access memory (RAM), a display, such as a liquid crystal display, an input interface, such as a mouse and a keyboard or a touchscreen, and a processor, such as a central processing unit (CPU) or a microcomputer. The communication interface is used when the terminal 12 communicates with the network device 16 or accesses a host 14 via the network device 16.

The hosts 14 may be a single server, such as a web server, which provides various items of data, such as webpage data, to a device having accessed the server via the communication network 24. Thanks to the technology called virtual hosting, the multiple hosts 14 may be defined in a virtual manner by using one server. Among the plural hosts 14, some hosts 14 may be a threat, which causes damage to a terminal 12. For example, such hosts 14 may send malware to a terminal 12. Among the plural hosts 14, there may be some hosts 14 that the terminals 12 have never accessed. Among such hosts 14, some hosts 14 may be a threat.

The network device 16 is interposed between the terminals 12 and the hosts 14 on a communication path. The network device 16 is connected to the multiple terminals 12 and executes the following types of processing when a terminal 12 is accessing and communicating with a host 14 via the communication network 24.

As one type of processing, the network device 16 sends various requests to the DNS server 18 in response to a demand from a terminal 12. For example, when the user of a terminal 12 has specified the uniform resource locator (URL) of a host 14 so as to access it, the network device 16 sends a request to conduct name resolution concerning a fully qualified domain name (FQDN), such as “www.fujixerox.co.jp”, which is the domain name of the host 14, included in the URL to the DNS server 18. In addition to the request to conduct name resolution, the network device 16 also sends a request to the DNS server 18 to obtain various items of information, such as a comment about the FQDN, stored in the DNS server 18.

A request sent from the network device 16 to the DNS server 18 contains a query type (also called a DNS record type) indicating the type of information that the network device 16 is requesting the DNS server 18 to send. Examples of the query types are “A” representing the IPv4 IP address of an FQDN, “AAAA” representing the IPv6 IP address of an FQDN, “CNAME” representing the alias of an FQDN (alias domain name), and “TXT” representing text information, such as a comment about an FQDN. To obtain the IPv4 IP address of an FQDN, for example, the network device 16 sends this FQDN and a request containing the query type “A” to the DNS server 18.

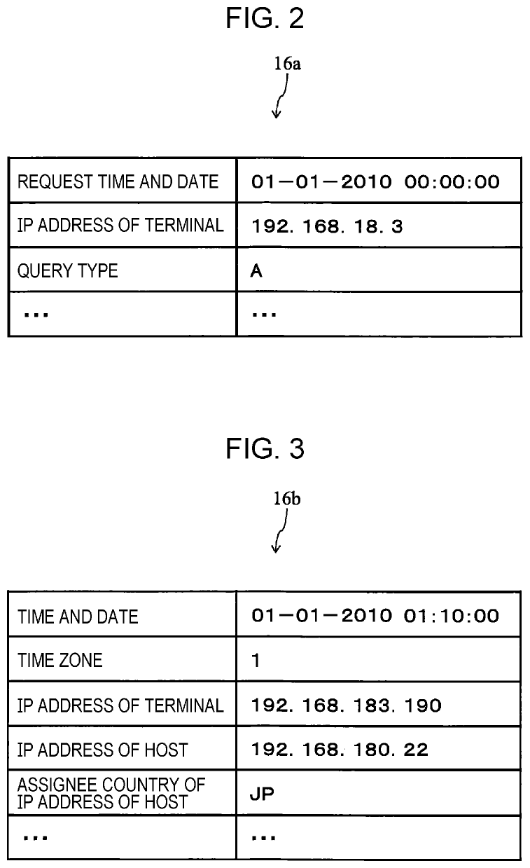

Every time a request is sent from the network device 16 to the DNS server 18, a query log 16a indicating a transmission history of this request is stored in the network device 16. FIG. 2 illustrates an example of the query log 16a corresponding to one request. The query log 16a indicates the time and date at and on which a request is sent to the DNS server 18 (hereinafter may be called the request time and date), the IP address of the terminal 12 that has requested the network device 16 to send the request, and information indicating the query type of this request. The IP address of the terminal 12 is used as an identifier for uniquely identifying the terminal 12. Instead of the IP address, another information that can uniquely identify the terminal 12 may be used and stored in the query log 16a.

Upon receiving the FQDN of the host 14 from the network device 16 to the DNS server 18, the DNS server 18 executes name resolution processing, and sends the IP address of the host 14 to the network device 16. Upon receiving the IP address of the host 14, the network device 16 can access the host 14 based on the IP address. Details of name resolution processing will be discussed later.

As another type of processing executed by the network device 16, every time a terminal 12 and a host 14 communicate with each other, the network device 16 generates a communication log 16b, which is the history of this communication, and stores it in the network device 16. In the exemplary embodiment, every time one communication session is performed, information, such as Internet control message protocol (ICMP) session information, is stored as the communication log 16b. The ICMP session information is information included in the IP header and the ICMP message of the payload of an Ethernet frame.

FIG. 3 illustrates an example of the communication log 16b corresponding to one communication session. The communication log 16b includes items of information concerning the communication time and date, time zone, IP address of a terminal 12, IP address of a host 14, and assignee country of the IP address of the host 14. The communication time and date indicates those at and on which the terminal 12 has accessed the host 14, namely, the time at which the terminal 12 and the host 14 have started to communicate with each other. The time zone indicates the period of time for which the terminal 12 has connected to the host 14. In the exemplary embodiment, the time zone can take values from 0 to 23. For example, if the time zone is “1”, it indicates that the terminal 12 and the host 14 have communicated during the period from 1:00 to 2:00. Information concerning the assignee country of the IP address of the host 14 may be obtained as a result of the network device 16 querying “Whois”, which is a query and response service storing the registered users and assignee countries of the individual IP addresses.

As another type of processing executed by the network device 16, the network device 16 also executes processing to ensure the security when a terminal 12 communicates with a host 14 via the communication network 24. In other words, the network device 16 serves to protect a terminal 12 from a host 14 which may be a threat. For example, the network device 16 has a firewall or an intrusion prevention system (IPS). The firewall or the IPS verifies data, such as a packet, sent from a host 14, and if the data is found to be improper data, the firewall or the IPS disconnects communication between the terminal 12 and the host 14. Improper data is data that cause or may cause damage to the terminal 12.

This will be explained more specifically. By using the firewall or the IPS, the network device 16 judges whether data, such as a packet, received from a host 14 is improper data. For example, the network device 16 detects improper data sent from a host 14 by monitoring communication between a terminal 12 and the host 14 based on the URL of the host 14 specified by the user of the terminal 12. If the network device 16 has determined that data sent from the host 14 is not improper data, it sends the data to the terminal 12. Then, the terminal 12 and the host 14 can start communicating with each other. In contrast, if the network device 16 has determined that data sent from the host 14 is improper data, it blocks the data, that is, it disconnects communication between the terminal 12 and the host 14, and informs the terminal 12 that communication with the host 14 is not allowed.

The result of the judgement as to whether data sent from a host 14 is improper data is stored in the memory of the network device 16 as a judgement log 16c. Regardless of whether data sent from a host 14 is improper data, the result of the judgement is stored as the judgement log 16c every time communication is performed between a terminal 12 and a host 14. The judgement log 16c includes the time at which the judgement has been made (communication time), information indicating a host 14, and information indicating whether the host 14 is a threat (whether improper data has been detected). In the exemplary embodiment, as the information indicating a host 14, at least the domain name, that is, the FQDN, of the host 14, is included in the judgement log 16c. More appropriately, as the information indicating a host 14, the IP address of the host 14, the name and the IP address of the name server 20 (which will be discussed in detail later) that manages the FQDN of the host 14, the assignee country of the IP address of the host 14, and the network name of the IP address of the host 14 may also be included in the judgement log 16c. The network name is a unique identifier appended to an IP address that a regional Internet registry (organization that manages IP addresses) allocates to the user of a terminal. If the user of a terminal wishes to have multiple IP addresses, the same network name is appended to these multiple IP addresses. However, this network name is still unique among the IP addresses other than those allocated to this user. The network name of the IP address of the host 14 may be obtained as a result of the network device 16 querying the above-described “Whois”.

The DNS server 18 is a device that sends various items of information in response to requests from various devices, such as the network device 16. In particular, the DNS server 18 is a device that converts a domain name into an IP address and vice versa.

Upon receiving the FQDN of a host 14 specified by a terminal 12 and a request including the query type “A” from the network device 16, the DNS server 18 executes name resolution processing concerning the FQDN so as to identify the IP address of the host 14 represented by the FQDN. In the exemplary embodiment, the DNS server 18 is a full-service resolver, and executes name resolution processing in cooperation with the multiple name servers 20.

Each of the name servers 20 is an authoritative server and manages domain names of a specific zone. For example, a certain name server 20 manages the domain name “xxx.net”, while another name server 20 manages the domain name “xxx.org”. More specifically, each name server 20 has a file called a zone file concerning the domain names of the zone managed by the name server 20. By referring to this zone file, each name server 20 identifies the zone of the domain names managed by the name server 20.

The DNS server 18 sends an FQDN received from the network device 16 to multiple name servers 20. Among the name servers 20 having received the FQDN, the name server 20 that manages this FQDN refers to the zone file, identifies the IP address associated with the FQDN, and sends the IP address to the DNS server 18. The DNS server 18 then sends the IP address received from the name server 20 (that is, the IP address of the host 14) and the IP address of this name server 20 to the network device 16.

The DNS server 18 may be integrated with at least some of the name servers 20. In this case, the DNS server 18 manages the domain names of a certain zone by itself, namely, the DNS server 18 has a zone file concerning the domain names of this zone.

The security server 22 is constituted by a server computer, for example. The security server 22 judges whether access from a terminal 12 to an unknown host 14 is insecure access (communication). That is, the security server 22 detects access to a host 14 which is a threat or access from a terminal 12 infected with malware. The unknown host 14 is a host 14 which the terminals 12 have never accessed before and for which the network device 16 has never judged whether data sent from this host 14 is improper data.

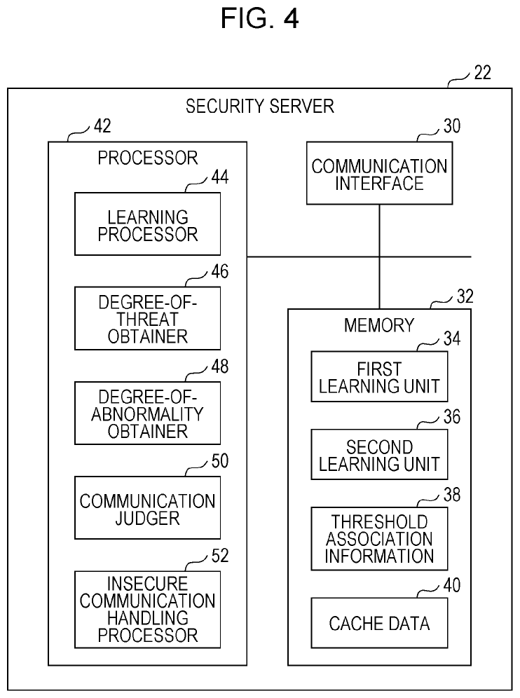

FIG. 4 is a block diagram illustrating the security server 22. The individual elements of the security server 22 will be explained below with reference to FIG. 4.

A communication interface 30 includes a network adapter, for example. The communication interface 30 has a function of communicating with another device, such as the network device 16, via the communication network 24.

A memory 32 includes a hard disk, a solid state drive (SSD), a ROM, or a RAM, for example. The memory 32 may be provided separately from a processor 42, which is discussed later, or be at least partially provided within the processor 42. An information processing program for operating the individual elements of the security server 22 is stored in the memory 32. A first learning unit 34, a second learning unit 36, threshold association information 38, and cache data 40 are stored in the memory 32, as shown in FIG. 4.

The first learning unit 34 is constituted by a deep neural network model, for example. The first learning unit 34 learns to output a degree of threat by using learning data in response to inputting of information indicating a host 14. As the learning data, the first learning unit 34 uses information indicating a host 14 and whether this host 14 is a threat. A host 14 for which the degree of threat is to be estimated by the first learning unit 34 will be called a subject host 14a. As a result of inputting information indicating a subject host 14a into the first learning unit 34, which has learned to output a degree of threat, the first learning unit 34 is able to output the degree of threat of the subject host 14a. The degree of threat is expressed by a numeric value representing the possibility (or the probability) of the subject host 14a being a threat. In the exemplary embodiment, the degree of threat can take values from 0 to 1. As the value is greater, the probability of the subject host 14a being a threat is higher. Details of the first learning unit 34 will be discussed later, together with an explanation of processing executed by a learning processor 44.

The second learning unit 36 is constituted by a neural network model, such as a recurrent neural network (RNN), or an autoencoder. The second learning unit 36 learns to output the degree of abnormality, which represents how abnormal access from a terminal 12 is, in response to inputting of a communication history of the terminal 12. The communication history is the history of access from a terminal 12 and is used as learning data by the second learning unit 36. The second learning unit 36 learns the features of communication frequently performed by a terminal (that is, the features of “usual” communication of the terminal 12), based on the communication history of the terminal 12. A terminal 12 for which the degree of abnormality is to be estimated by the second learning unit 36 will be called a subject terminal 12a. As a result of inputting the communication history of a subject terminal 12a into the second learning unit 36, which has learned to output the degree of abnormality, the second learning unit 36 is able to output the degree of abnormality regarding access from the subject terminal 12a. The degree of abnormality is expressed by the numeric value representing the difference between the features of communication frequently performed by a terminal 12, which have been learned by the second learning unit 36, and the features of communication represented by the history of access from the corresponding subject terminal 12a. Usually, the features of communication frequently performed by a terminal 12 under the normal conditions (when the terminal 12 is not infected with malware) and those of a terminal 12 under the abnormal conditions (when the terminal 12 is infected with malware) are different from each other. Normally, the features of communication frequently performed by a terminal 12 under the normal conditions do not vary significantly. The degree of abnormality can thus be regarded as an index representing the probability of a terminal 12 being infected with malware. In the exemplary embodiment, as well as the degree of threat, the degree of abnormality takes values from 0 to 1. As the degree of abnormality is greater, the difference between the features of communication of a terminal 12 learned by the second learning unit 36 and those of communication indicated by the communication history of the corresponding subject terminal 12a is greater. Details of the second learning unit 36 will also be discussed later, together with an explanation of processing executed by the learning processor 44.

The actual entity of each of the first and second learning units 34 and 36 is constituted by a program which defines the structure of the learning unit, various parameters regarding the learning unit, and a processing execution program for executing processing on input data. Accordingly, storing the first learning unit 34 or the second learning unit 36 in the memory 32 means storing the above-described programs and parameters in the memory 32.

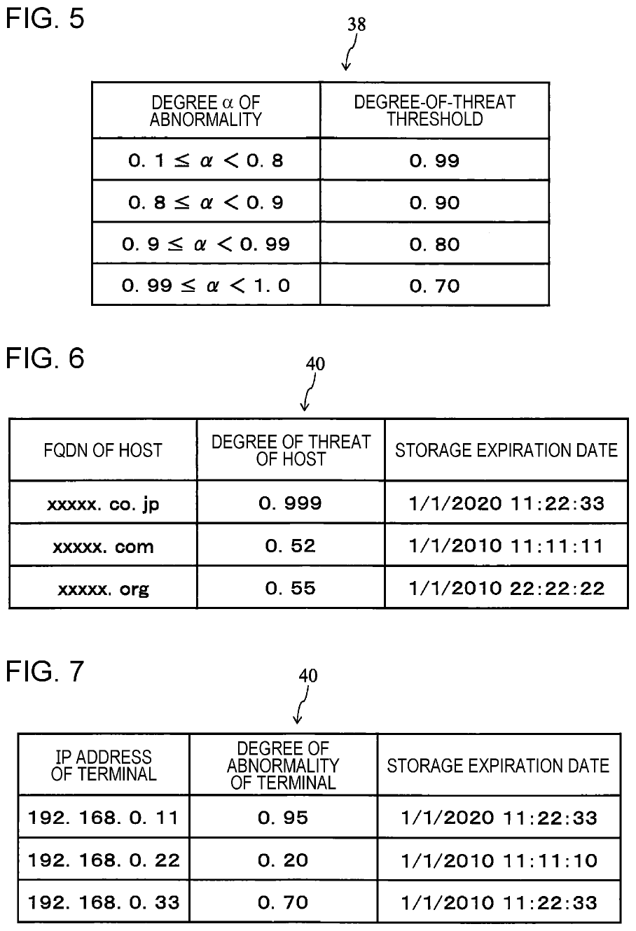

The threshold association information 38 is information indicating the association between the degree of abnormality of a terminal 12 and a degree-of-threat threshold, which is a threshold of the degree of threat of a host 14. FIG. 5 illustrates an example of the threshold association information 38. In the example in FIG. 5, the degree-of-threat threshold “0.99” is associated with the degree a of abnormality which is 0.1 or greater and smaller than 0.8; the degree-of-threat threshold “0.90” is associated with the degree a of abnormality which is 0.8 or greater and smaller than 0.9; the degree-of-threat threshold “0.80” is associated with the degree a of abnormality which is 0.9 or greater and smaller than 0.99; and the degree-of-threat threshold “0.70” is associated with the degree a of abnormality which is 0.99 or greater and smaller than 1.0. In this manner, a smaller degree-of-threat threshold is associated with a greater degree a of abnormality. The threshold association information 38 is referred to by a communication judger 50, which will be discussed later. An explanation of how to use the threshold association information 38 will be given later, together with a description of processing executed by the communication judger 50.

The cache data 40 is data stored in the memory 32 temporarily (in other words, within a limited period of time). The actual entity of the cache data 40 is information indicating the degree of threat of a host 14 output from the first learning unit 34 or the degree of abnormality of a terminal 12 output from the second learning unit 36.

FIG. 6 is a table illustrating information indicating the degree of threat of a host 14, which is a first example of the cache data 40. In the table shown in FIG. 6, one record represents one item of cache data 40. The cache data 40 shown in FIG. 6 is stored in the memory 32 in such a manner that information for identifying a host 14 (FQDN of the host 14 in FIG. 6), the degree of threat of the host 14, and the storage period of the cache data 40 are associated with each other. The storage period indicates how long the cache data 40 will be stored in the memory 32, which is determined in advance. In the example in FIG. 6, the storage expiration date is indicated as the storage period. For example, after the lapse of a certain period of time after the cache data 40 is stored in the memory 32, the cache data 40 is deleted from the memory 32.

FIG. 7 is a table illustrating information indicating the degree of abnormality of a terminal 12, which is a second example of the cache data 40. In the table shown in FIG. 7, as well as that in FIG. 6, one record represents one item of cache data 40. The cache data 40 shown in FIG. 7 is stored in the memory 32 in such a manner that information for identifying a terminal 12 (IP address of the terminal 12 in FIG. 7), the degree of abnormality of the terminal 12, and the storage period (storage expiration date in FIG. 7) of the cache data 40 are associated with each other.

Referring back to FIG. 4, the processor 42 will be explained. As a result of reading the information processing program stored in the memory 32, the processor 42 implements functions such as a learning processor 44, a degree-of-threat obtainer 46, a degree-of-abnormality obtainer 48, a communication judger 50, and an insecure communication handling processor 52.

The learning processor 44 executes learning processing for causing the first and second learning units 34 and 36 to perform learning.

Learning processing performed by the first learning unit 34 will first be discussed. The learning processor 44 causes the first learning unit 34 to learn to output the degree of threat of a host 14 in response to inputting of information indicating the host 14. To perform this learning, the first learning unit 34 uses as learning data information indicating a host 14 and whether this host 14 is a threat. More specifically, as the learning data, a threat FQDN list, which is a list of threat FQDNs, and a safe FQDN list, which is a list of threat-free FQDNs, that are provided by various organizations may be used. In this case, an FQDN included in the threat FQDN list serves as information indicating a host 14, and information that the host 14 represented by this FQDN is a threat serves as training data. Alternatively, an FQDN included in the safe FQDN list serves as information indicating a host 14, and information that the host 14 represented by this FQDN is not a threat serves as training data. By using such learning data, the first learning unit 34 learns the features of threat FQDNs or those of threat-free FQDNs so that it can estimate the degree of threat of an unknown host 14 represented by an unknown FQDN and output the degree of threat of the unknown host 14.

Alternatively, the learning processor 44 may cause the first learning unit 34 to learn to output the degree of threat of a host 14 by using data based on the judgement logs 16c received from the network device 16 as learning data. More specifically, the learning processor 44 executes learning processing for causing the first learning unit 34 to perform learning by using the following information in each judgement log 16c as learning data: the FQDN of a host (that is, the FQDN of the host 14 accessed from a terminal 12 in the past) and whether this host 14 is a threat.

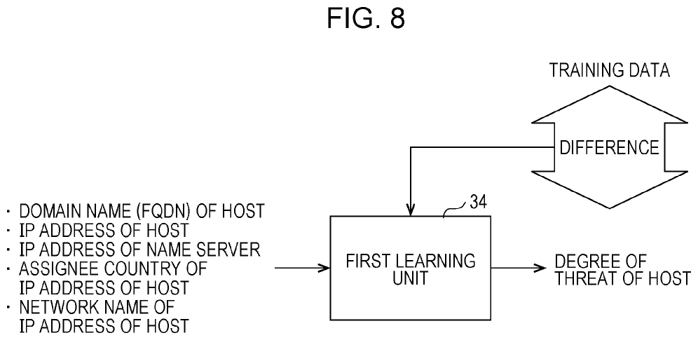

FIG. 8 is a conceptual diagram illustrating an example of learning processing executed by the first learning unit 34 under the control of the learning processor 44. The learning processor 44 inputs the FQDN of a host 14 included in a judgement log 16c into the first learning unit 34, and causes the first learning unit 34 to output the degree of threat of the host 14. The learning processor 44 then causes the first learning unit 34 to learn to output the degree of threat, based on the difference between the degree of threat output from the first learning unit 34 and training data, that is, information indicating whether this host 14 is a threat. As a result of the learning processor 44 repeating this learning processing, the first learning unit 34, which has completed the above-described learning, becomes able to output the degree of threat of a host 14 in response to inputting of the FQDN of this host 14.

As information indicating a host 14, which is part of the learning data, in addition to or instead of the FQDN of the host 14, the IP address of the host 14 and the name and the IP address of the name server 20 that manages this FQDN, which are included in the judgement log 16c, may be used.

Using the name and the IP address of the name server 20 in addition to the IP address of a host 14 makes it possible to uniquely specify the host 14 if this host 14 is a name-based virtual host. One IP address is allocated to multiple name-based virtual hosts 14. With a combination of the IP address of a host 14 and information concerning the name server 20 that manages the domain name of this host 14, the host 14 can be uniquely identified. The reason for this is as follows. Although the same IP address is allocated to multiple hosts 14 (name-based virtual hosts), these multiple hosts 14 have different domain names. It is thus highly likely that the name servers 20 that manage the respective domain names of these hosts 14 are different from each other. By combining the IP address of a host 14 and information concerning the name server 20 that manages the domain name of this host 14 can uniquely identify the host 14.

To enable the first learning unit 34 to output the degree of threat of a host 14 with higher accuracy, at least one of the assignee country of the IP address of the host 14 and the network name of the IP address of the host 14 may be added to the learning data.

If the number of threat hosts 14 varies among the assignee countries of the IP addresses of hosts 14, adding the assignee country of the IP address of a host 14 to the learning data allows the first learning unit 34 to estimate the degree of threat of a host 14 based on the assignee country of the IP address of this host 14.

If a malicious user applies for multiple IP addresses to a regional Internet registry, the same network name is appended to these IP addresses. The multiple hosts 14 represented by these IP addresses appended with the same network name are managed by this malicious user and are highly likely to become a threat. As a result of adding the network name of the IP address of a host 14 to learning data, the first learning unit 34 is able to estimate the degree of threat of a host 14 based on the network name of the IP address of this host 14. More specifically, if the first learning unit 34 has found a host 14 represented by the IP address appended with the same network name as the host 14 which is already determined to be a threat, it can raise the degree of threat of this host 14.

Regardless of whether the FQDN list or the judgement log 16c is used as the learning data, training data is included in the learning data, and the first learning unit 34 performs learning based on the difference between output from the first learning unit 34 and the training data. It can thus be said that the first learning unit 34 performs learning in a supervised manner. As the first learning unit 34, any type of learning unit may be used if it learns to output the degree of threat of a host 14 in response to inputting of information indicating this host 14 by using as learning data information indicating a host 14 and whether this host 14 is a threat.

Learning processing performed by the second learning unit 36 will now be discussed. The learning processor 44 causes the second learning unit 36 to learn to output the degree of abnormality of access from a terminal 12 in response to inputting of the communication history of this terminal 12. To perform this learning, the second learning unit 36 uses the communication history of the terminal 12 as learning data.

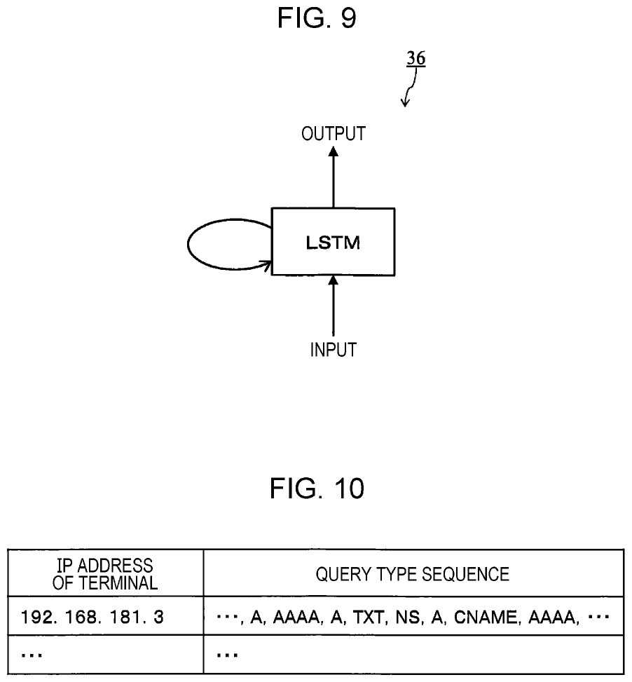

One of the typical modes of the second learning unit 36 is a long short-term memory (LSTM), such as that shown in FIG. 9. The LSTM is an extended version of the RNN. Plural items of input data are sequentially input into the LSTM. When the current item of input data is input into the LSTM, output data in response to the previous item of input data is also input into the LSTM. This enables the LSTM to output data in response to the current item of input data by taking the features of the previous item of input data into consideration. This type of learning unit is also one type of the RNN.

The learning processor 44 causes the second learning unit 36 to perform LSTM learning by using the query logs 16a received from the network device 16 as learning data. The query logs 16a serve as the communication histories of the terminals 12.

Based on the information for identifying the individual terminals 12 (IP addresses of the terminals 12 in the exemplary embodiment) included in the query logs 16a, the learning processor 44 first separates the query logs 16a according to the terminal 12. Then, for each terminal 12, based on the request time and date included in each query log 16a, the learning processor 44 rearranges the query logs 16a in chronological order of sending time of the corresponding requests. Then, the learning processor 44 extracts the query types from each of the query logs 16a rearranged in chronological order so as to generate a query type sequence for each of the terminals 12. An example of the query type sequence generated by the learning processor 44 is shown in FIG. 10.

The learning processor 44 then causes the LSTM to perform learning for each terminal 12 by using the above-described query type sequence for the corresponding terminal 12 as learning data. More specifically, the learning processor 44 causes the LSTM to learn to output the features of an input query type sequence. To enable the LSTM to perform learning for each terminal 12, the single LSTM may be used for the individual terminals 12 and information for identifying a terminal 12 is input into the LSTM, together with learning data. Alternatively, individual LSTMs may be prepared for the respective terminals 12. A description will be given below of a case in which the LSTM prepared for a specific single terminal 12 performs learning.

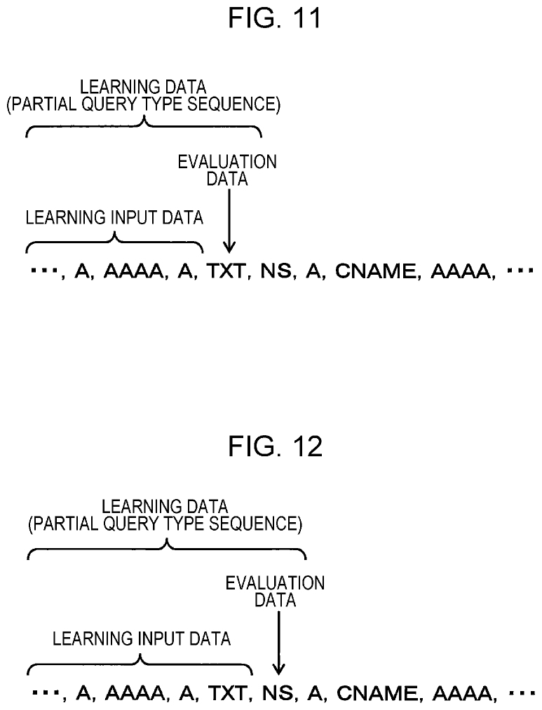

The query type sequence is one sequence consisting of a set of multiple query types. To increase the number of items of learning data (the number of samples), a partial query type sequence, which is part of one query type sequence and consists of multiple query types consecutively arranged in this query type sequence, is set as one item of learning data. For example, as shown in FIG. 11, it is assumed that a query type sequence is “. . . , A, AAAA, A, TXT, NS, A, CNAME, AAAA, . . . ”, and “. . . , A, AAAA, A, TXT”, which is a partial query type sequence, of this query type sequence is set as one item of learning data. In the exemplary embodiment, the final query type (“TXT” in this example) of the partial query type sequence is used as evaluation data forming this learning data, while the other part (“. . . , A, AAAA, A”) of the partial query type sequence is used as learning input data forming this learning data.

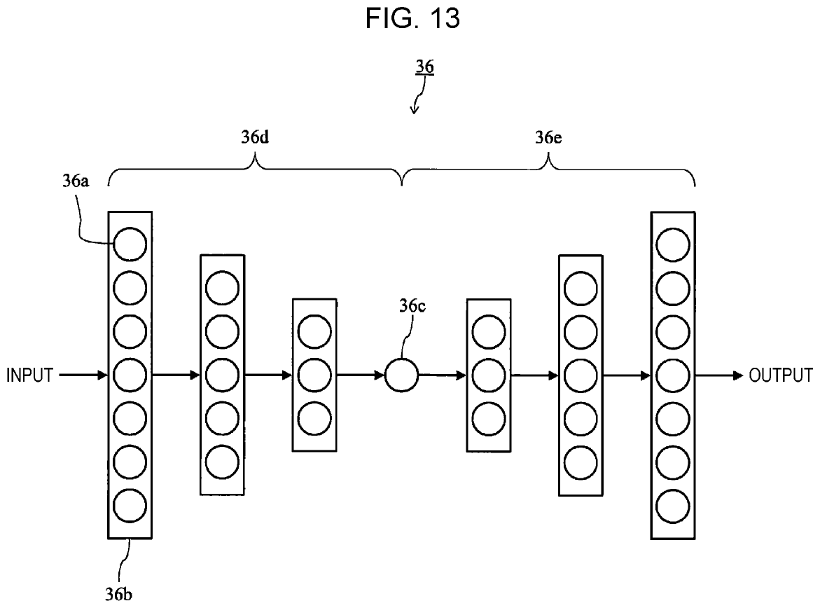

From the same query type sequence, the learning data may be formed, as shown in FIG. 12. In the example in FIG. 12, a partial query “. . . , A, AAAA, A, TXT, NS” is used as one item of learning data, in which “. . . , A, AAAA, A, TXT” is learning input data, while “NS” is evaluation data.

The learning processor 44 inputs learning input data of learning data into the LSTM. More specifically, multiple query types indicated by the learning input data are sequentially input into the LSTM. For example, when the learning input data is “. . . , A, AAAA, A, TXT”, the first query type “A” is input into the LSTM. Then, the LSTM outputs the features of the query type “A”. This output is also called a hidden state vector. Then, when the second query type “AAAA” is input into the LSTM, the LSTM outputs a hidden state vector by considering both of the input query type “AAAA” and the previous output (hidden state vector) corresponding to the first query type “A”. The hidden state vector output from the LSTM thus reflects, not only the features of the second query type “AAAA”, but also those of the first query type “A”. As a result of repeating this processing, when the final query type “TXT” of the learning input data is input into the LSTM, the LSTM outputs the final output which reflects the features of the previously input query types “A, AAAA, A” and those of the query type “TXT”.

In the exemplary embodiment, the LSTM outputs the probability of each of multiple query types forming input learning input data being the query type which follows the input learning input data. The probability is output as the numeric value. For example, the probabilities of the multiple query types in the above-described example being the query type which follows the input learning input data are as follows: “A” is 0.95; “AAAA” is 0.03; and “TXT” is 0.00000007.

To enable the LSTM to predict the query type which follows learning input data, it is necessary that a certain number of query types or more be included in the learning input data. The learning processor 44 thus defines items of learning data from a query type sequence so that each item of learning input data includes a certain number of query types or more.

The learning processor 44 causes the LSTM to perform learning based on the difference between output from the LSTM and evaluation data (that is, correct answer data).

As a result of the learning processor 44 repeating the above-described learning processing, based on an input query type sequence, the LSTM, which has completed learning, is able to output the features of this input query type sequence. In the exemplary embodiment, the LSTM, which has completed learning, is able to output the probability of the query type which follows learning input data by taking the features of the learning input data into consideration.

Under the normal conditions, that is, when a terminal 12 is not infected with malware, a query type sequence obtained from multiple requests sent to the DNS server 18 in response to a demand from the terminal 12 tends to have specific features. For example, the query type sequence corresponding to a certain terminal 12 is likely to have a pattern of “A, AAAA, A, TXT”. Additionally, the features of such a query type sequence vary among the terminals 12. One of the reasons for this is that the user of a terminal 12 is likely to act according to a specific behavior pattern. For example, if the user of a certain terminal 12 tends to access plural hosts 14 in a specific order or to obtain information from the DNS server 18 in a specific order, the query type sequence corresponding to this terminal 12 represents the tendency of this user. That is, the features of a query type sequence corresponding to a certain terminal 12 represent those of communication performed by this terminal 12. It can thus be said that the LSTM learns the features of communication frequently performed by the terminal 12.

In this manner, the LSTM learns the features of communication frequently performed by the terminal 12. Accordingly, when a certain query type sequence is input into the LSTM, the LSTM is able to judge whether the features of communication performed by the terminal 12 represented by this query type sequence are the same as those of the terminal 12 learned by the LSTM, that is, those of “usual” communication of the terminal 12. Then, based on the difference between the features of communication of the terminal 12 indicated by the input query type sequence and the features of communication of the terminal 12 learned by the LSTM, the LSTM is able to output the probability that the terminal 12 is performing communication different from “usual” communication, that is, the probability of the terminal 12 being infected with malware.

Another typical mode of the second learning unit 36 is an autoencoder, such as that shown in FIG. 13. The autoencoder is a learning unit. The autoencoder is constituted by multiple layers 36b, each of which includes multiple neurons 36a. The autoencoder includes an encoder 36d and a decoder 36e. The encoder 36d reduces the dimensionality of input data (compresses the features of input data) so as to extract a compressed feature vector 36c representing the features of input data. The decoder 36e expands the dimensionality from the compressed feature vector 36c so as to reconstruct and output the original input data. The encoder 36d and the decoder 36e are each constituted by multiple layers 36b. In the encoder 36d, the number of neurons 36a included in the layer 36b, that is, the dimensionality of data, is gradually decreased in the direction from the layer 36b closer to the input side toward the layer 36b on the deeper side. In the decoder 36e, the number of neurons 36a included in the layer 36b is gradually increased in the direction from the layer 36b closer to the feature vector 36c to the layer 36b closer to the output side. In each of the encoder 36d and the decoder 36e, all the neurons 36a included in a layer 36b are coupled with those in an adjacent layer 36b.

The learning processor 44 executes learning processing for causing the autoencoder to perform learning based on the communication logs 16b received from the network device 16 as learning data. The communication logs 16b serve as the histories of communication performed by the terminals 12.

The learning processor 44 first converts information included in each communication log 16b into a format suitable to be learning data used by the autoencoder. More specifically, the learning processor 44 sequentially links the numeric values of individual segments (also called octets in IPv4) of the IP address of the terminal 12 and those of the IP address of the host 14 included in the communication log 16b, and sets the linked numeric values as learning data. For example, if the communication log 16b is represented by the content shown in FIG. 3, the learning data results in “192, 168, 183, 190, 192, 168, 180, 22”, which is a combination of the IP address of the terminal 12 and that of the host 14. That is, the IP address of the terminal 12 and that of the host 14 are used as the learning data.

As the learning data, at least one of information indicating the time zone and that of the assignee country of the IP address of the host 14 included in the communication log 16b may also be used. In this case, information indicating the time zone and/or that of the assignee country are linked with the above-described combination of the IP address of the terminal 12 and that of the host 14. In the exemplary embodiment, the learning data is constituted by information indicating the time zone, the IP address of the terminal 12, the IP address of the host 14, and information indicating the assignee country of the IP address of the host 14. For example, if the communication log 16b is represented by the content shown in FIG. 3, the learning data results in “1, 192, 168, 183, 190, 192, 168, 180, 22, jp”.

In the above-described learning processing, as many samples of learning data as the communication logs 16b stored in the network device 16 are generated. By using the generated samples of learning data, the learning processor 44 causes the autoencoder to perform learning.

When the learning processor 44 has input learning data into the autoencoder as input data, the encoder 36d of the autoencoder extracts the compressed feature vector 36c from the features of the input data, and then, the encoder 36e reconstructs the input data from the feature vector 36c and outputs the input data (see FIG. 13). The learning processor 44 causes the autoencoder to perform learning based on the difference between the input data input into the autoencoder and the output data output from the autoencoder.

As a result of the learning processor 44 repeating the above-described learning processing, the autoencoder learns the features of input data. Then, if input data input into the autoencoder indicates features learned by the autoencoder, the autoencoder is able to reconstruct this input data based on the compressed feature vector 36c extracted from the input data and output the reconstructed input data as output data. That is, if the features of input data are those learned by the autoencoder, the autoencoder is able to output the input data as output data. In other words, if the features of input data are not those learned by the autoencoder, the autoencoder is unable to reconstruct this input data and to output it as output data. In this case, the output data does not match the input data.

Under the normal conditions, that is, when a terminal 12 is not infected with malware, it tends to access specific plural hosts 14. One of the reasons for this is that the user of a terminal 12 is likely to act according to a specific behavior pattern. A combination of the IP address of a terminal 12 and that of a host 14 can thus represent the features of communication performed by the terminal 12. More appropriately, a combination of the IP address of a terminal 12, that of a host 14, the time zone, and the assignee country of the IP address of the host 14 represents the features of communication performed by the terminal 12. It can thus be said that the autoencoder, which performs learning by using the above-described learning data, learns the features of communication frequently performed by the terminal 12.

In this manner, the autoencoder has learned the features of communication frequently performed by the terminals 12. Accordingly, in response to inputting of input data indicating the features of communication of a terminal 12 into the autoencoder, if the features of communication from this terminal 12 are the same as those of communication of the terminal 12 learned by the autoencoder, that is, those of “usual” communication of the terminal 12, the autoencoder is able to output data equivalent to the input data. If the features of communication from this terminal 12 are not the same as those of “usual” communication of the terminal 12, the autoencoder outputs data different from the input data. Then, based on the difference between the input data and the output data, the autoencoder is able to output the probability that the terminal 12 is performing communication different from “usual” communication, that is, the probability of the terminal 12 being infected with malware.

The learning data used for the second learning unit 36 is not appended with a label indicating whether this learning data is obtained from communication performed by a terminal 12 which is not infected with malware or from communication performed by a terminal infected with malware. The second learning unit 36 thus performs learning in an unsupervised manner. As the second learning unit 36, any type of learning unit may be used if it learns to output the degree of abnormality of access from a terminal 12 by using the communication history of the terminal 12 as learning data.

Referring back to FIG. 4, the degree-of-threat obtainer 46 and the degree-of-abnormality obtainer 48 will be explained. As a result of inputting information indicating a subject host 14a into the first learning unit 34, which has completed learning, the degree-of-threat obtainer 46 obtains the degree of threat of the subject host 14a.

The type of information indicating the subject host 14a is determined in accordance with information indicating a host 14 used by the first learning unit 34 as learning data. For example, if the first learning unit 34 has performed learning by using the FQDN of a host 14, the degree-of-threat obtainer 46 inputs the FQDN of the subject host 14a into the first learning unit 34, which has completed learning. If the first learning unit 34 has performed learning by using the IP address of a host 14 and the IP address of the name server 20 that manages the FQDN of this host 14, the degree-of-threat obtainer 46 inputs the IP address of the subject host 14a and the IP address of the name server 20 that manages the FQDN of the subject host 14a into the first learning unit 34, which has completed learning. If the first learning unit 34 has performed learning by using the assignee country and the network name of the IP address of a host 14, as well as the FQDN of the host 14, the degree-of-threat obtainer 46 inputs the assignee country and the network name of the IP address of the subject host 14a, as well as the information indicating the subject host 14a, into the first learning unit 34.

This will be explained more specifically. When a terminal 12 has sent the FQDN of a subject host 14a to the network device 16 to try to access the subject host 14a, the network device 16 sends this FQDN to the security server 22. The network device 16 also sends the IP address of the subject host 14a and the IP address of the name server 22 that manages the FQDN of the subject host 14a, which are received from the DNS server 18 based on the FQDN, to the security server 22. The network device 16 also sends information indicating the assignee country and the network name of the IP address of the subject host 14a, which are obtained from “Whois”, for example, to the security server 22. The degree-of-threat obtainer 46 inputs the above-described items of information into the first learning unit 34, which has completed learning.

As a result of inputting the communication history of a subject terminal 12a into the second learning unit 36, which has completed learning, the degree-of-abnormality obtainer 48 obtains the degree of abnormality of access from the subject terminal 12a.

If the second learning unit 36 is constituted by the above-described LSTM, the degree-of-abnormality obtainer 48 obtains the degree of abnormality of access from the subject terminal 12a in the following manner.

As a result of executing processing similarly to the learning processor 44, based on the query logs 16a of the subject terminal 12a, the degree-of-abnormality obtainer 48 first obtains a query type sequence from which the degree of abnormality will be detected (hereinafter called a subject query type sequence). The degree-of-abnormality obtainer 48 inputs the obtained subject query type sequence into the LSTM, which has completed learning. If the single LSTM is used for the plural terminals 12, information for identifying the subject terminal 12a (IP address of the subject terminal 12a in this example) is input into the LSTM, together with the subject query type sequence. If individual LSTMs are prepared for the respective terminals 12, the degree-of-abnormality obtainer 48 inputs the subject query type sequence to the corresponding LSTM.

Calculation processing for the degree of abnormality of access from the subject terminal 12a when the second learning unit 36 is the LSTM will be described below in detail. The degree-of-abnormality obtainer 48 first defines a partial subject query type sequence consisting of a certain number of query types or more, starting from the head of the subject query type sequence. The degree-of-abnormality obtainer 48 then inputs the defined partial subject query type sequence into the LSTM.

Based on the partial subject query type sequence, the LSTM predicts the query type which follows the partial subject query type sequence, and outputs the probability of each of the query types being the query type which follows the partial subject query type sequence. Among the probabilities output from the LSTM, the degree-of-abnormality obtainer 48 sets the probability of the actual query type which follows the partial subject query type sequence to be the individual score of the query type which follows the partial subject query type sequence.

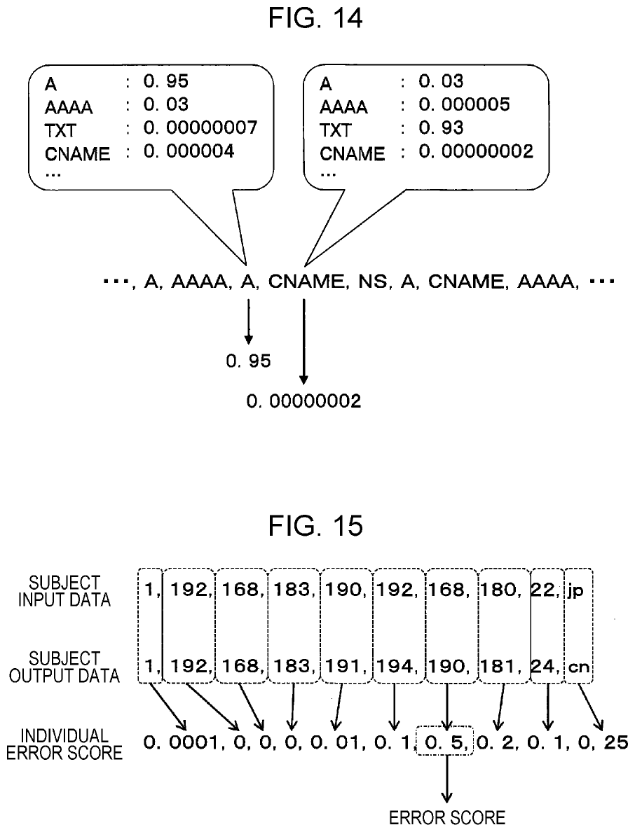

This will be explained in detail with reference to FIG. 14. The subject query type sequence “. . . , A, AAAA, A, CNAME, NS, A, CNAME, AAAA, . . . ” is shown in FIG. 14. The degree-of-abnormality obtainer 48 first inputs “. . . , A, AAAA” into the LSTM as a partial subject query type sequence. Based on this partial subject query type sequence “. . . , A, AAAA”, the LSTM outputs the probability of the query type which follows this partial subject query type sequence. As shown in FIG. 14, the probabilities of the query types being the query type which follows the partial subject query type sequence are as follows: “A” is 0.95; “AAAA” is 0.03; “TXT” is 0.00000007; and “CNAME” is 0.000004.

Then, the degree-of-abnormality obtainer 48 checks the subject query type sequence and identifies the actual query type “A” which follows the input partial subject query type sequence “. . . , A, AAAA”. Among the probabilities output from the LSTM, the degree-of-abnormality obtainer 48 sets the probability (“0.95”) of “A”, which is the identified actual query type, to be the individual score of the query type “A”. As the individual score is smaller, the subject query type sequence is more abnormal, that is, the difference between the features of communication of the subject terminal 12a and those of “usual” communication of the corresponding terminal 12 is greater.

Then, the degree-of-abnormality obtainer 48 adds the query type which follows the partial subject query type sequence to the partial subject query type sequence. In the example in FIG. 14, the resulting partial subject query type sequence is “. . . , A, AAAA, A”. Based on this partial subject query type sequence “. . . , A, AAAA, A”, the LSTM outputs the probability of the query type which follows this partial subject query type sequence. As shown in FIG. 14, the probabilities of the query types being the query type which follows the partial subject query type sequence are as follows: “A” is 0.03; “AAAA” is 0.000005; “TXT” is 0.93; and “CNAME” is 0.00000002. Then, among the probabilities output from the LSTM, the degree-of-abnormality obtainer 48 sets the probability (“0.00000002”) of “CNAME”, which is the actual query type following the partial subject query type “. . . , A, AAAA, A”, to be the individual score of the query type “CNAME”.

In this manner, the degree-of-abnormality obtainer 48 sequentially adds a query type one by one to the corresponding partial subject query type sequence so as to calculate the individual score of the query type which follows the corresponding partial subject query type sequence.

The degree-of-abnormality obtainer 48 calculates the degree of abnormality of access from the subject terminal 12a, based on the individual score calculated for each query type included in the subject query type sequence.

To calculate the degree of abnormality of access from the subject terminal 12a based on the individual scores, various methods can be employed. In the exemplary embodiment, the degree-of-abnormality obtainer 48 calculates the degree of abnormality of access from the subject terminal 12a by executing the following processing.

Among the individual query types in the subject query type sequence, the degree-of-abnormality obtainer 48 first extracts a query type only for which the individual score is smaller than or equal to a predetermined threshold (0.00001, for example). Then, by referring to the corresponding query logs 16a, the degree-of-abnormality obtainer 48 extracts the request time and date of a request corresponding to the extracted query type from each of the referred query logs 16a. The degree-of-abnormality obtainer 48 then generates an abnormality log including the extracted request time and date and the individual score calculated for the corresponding extracted query type. The abnormality log may include the corresponding query type and the IP address of the terminal 12 having sent a query corresponding to this query type.

Then, for each time window, which is a frame for a certain time from the present to the past (ten minutes, for example), the degree-of-abnormality obtainer 48 calculates an evaluation score based on the individual scores included in the generated abnormality logs. In the exemplary embodiment, the degree-of-abnormality obtainer 48 calculates the evaluation score based on the measurement called perplexity. More specifically, the degree-of-abnormality obtainer 48 sets the time window to be a certain time frame, and then calculates −log₂P of the individual score P included in each abnormality log within the set time window (the request time and date indicated by the abnormality log is within this time window). The degree-of-abnormality obtainer 48 then calculates the average of −log₂P of the individual scores P within the time window and sets the calculated average to be the evaluation score for this time window. As the evaluation score is higher, the subject query type sequence is more abnormal, that is, the difference between the features of communication of the subject terminal 12a and those of “usual” communication performed by the corresponding terminal 12 is greater. The degree-of-abnormality obtainer 48 adjusts the calculated evaluation score to be a range of 0 to 1 and sets the resulting value as the degree of abnormality of access from the subject terminal 12a.

If the second learning unit 36 is constituted by the above-described autoencoder, the degree-of-abnormality obtainer 48 obtains the degree of abnormality of access from the subject terminal 12a in the following manner.

Based on the communication log 16b regarding communication of the subject terminal 12a, as a result of executing processing similarly to the learning processor 44, the degree-of-abnormality obtainer 48 first generates input data indicating the numeric values of the individual segments of the IP address of the subject terminal 12a and those of a host 14 to which the subject terminal 12a has connected (hereinafter such a host 14 will be called a subject host 14a) linked with each other. Such input data will be called subject input data. If the autoencoder has performed learning with learning data to which information indicating the time zone is attached, the degree-of-abnormality obtainer 48 generates, based on the communication log 16b, subject input data indicating information about the time zone, the numeric values of the individual segments of the IP address of the subject terminal 12a, and those of the subject host 14a linked with each other. If the autoencoder has performed learning with learning data to which information indicating the assignee country of the IP address of the subject host 14a is attached, the degree-of-abnormality obtainer 48 generates, based on the communication log 16b, subject input data indicating the numeric values of the individual segments of the IP address of the subject terminal 12a, those of the subject host 14a, and information about the assignee country of the IP address of the subject host 14a linked with each other. In the exemplary embodiment, the degree-of-abnormality obtainer 48 generates subject input data indicating information about the time zone, the numeric values of the individual segments of the IP address of the subject terminal 12a, those of the subject host 14a, and information about the assignee country of the IP address of the subject host 14a linked with each other.

The degree-of-abnormality obtainer 48 inputs the generated subject input data into the autoencoder, which has completed learning, and compares this subject input data with output data output from the autoencoder. Output data obtained from the autoencoder in response to subject input data into the autoencoder will be called subject output data. Based on the comparison result, the degree-of-abnormality obtainer 48 calculates the degree of abnormality of access from the subject terminal 12a.

Calculation processing for the degree of abnormality of access from the subject terminal 12a when the second learning unit 36 is the autoencoder will be described below in detail. FIG. 15 illustrates an example of subject input data input into the autoencoder, which has completed learning, and that of subject output data output from the autoencoder in response to the subject input data. The degree-of-abnormality obtainer 48 compares the subject input data and the subject output data and then calculates the error score representing the difference between the subject input data and the subject output data.

More specifically, the degree-of-abnormality obtainer 48 compares individual items of information represented by the subject input data and those by the subject output data, that is, information indicating the time zone, individual segments of the IP address of the subject terminal 12a, those of the subject host 14a, and the assignee country of the IP address of the subject host 14a represented by the subject input data and those by the subject output data. Based on the comparison results, the degree-of-abnormality obtainer 48 calculates an individual error score for each item of information. For example, as shown in FIG. 15, upon comparing the time zone “1” represented by the subject input data and the time zone “1” represented by the subject output data, the degree-of-abnormality obtainer 48 calculates the individual error score to be “0.0001”, which indicates the difference between the time zone represented by the subject input data and that by the subject output data. The degree-of-abnormality obtainer 48 also compares the first segment “192” of the IP address of the subject host 14a represented by the subject input data and the first segment “194” represented by the subject output data, and calculates the individual error score to be “0.1”, which indicates the difference therebetween.

To calculate individual error scores, various calculation methods may be employed, and a desired method can be used. In the exemplary embodiment, individual error scores are calculated such that, as the difference between subject input data and subject output data is greater, the individual error scores also become greater, and as the difference between subject input data and subject output data is smaller, the individual error scores also become smaller.

Based on the multiple individual error scores calculated for the individual items of information represented by the subject input data and those by the subject output data, the degree-of-abnormality obtainer 48 calculates the error score representing the overall difference between the entire subject input data and the entire subject output data. In the exemplary embodiment, the highest value of the individual error scores calculated between the subject input data and the subject output data is set to be the error score indicating the overall difference therebetween. In the example in FIG. 15, the individual error score “0.5” between the second segment “168” of the IP address of the subject host 14a indicated by the subject input data and the second segment “190” of the IP address of the subject host 14a indicated by the subject output data is the highest value. Accordingly, the error score representing the overall difference between the subject input data and the subject output data is set to be “0.5”. Another approach may be taken to calculate the error score as long as the error score becomes higher as the difference between subject input data and subject output data is greater. For example, the average of multiple individual error scores may be used as the overall error score.

The degree-of-abnormality obtainer 48 adjusts the calculated error score to be a range of 0 to 1 and sets the resulting value as the degree of abnormality of access from the subject terminal 12a.

Referring back to FIG. 4, the communication judger 50 will be explained. Based on the degree of threat of the subject host 14a obtained by the degree-of-threat obtainer 46 and the degree of abnormality of access from the subject host 12a obtained by the degree-of-abnormality obtainer 48, the communication judger 50 executes processing for judging whether access from the subject terminal 12a to the subject host 14a is insecure communication.

The communication judger 50 first refers to the threshold association information 38 (see FIG. 5) and identifies the degree-of-threat threshold associated with the degree of abnormality of access from the subject terminal 12a obtained by the degree-of-abnormality obtainer 48. For example, if the content of the threshold association information 38 is that shown in FIG. 5, when the degree of abnormality of access from the subject terminal 12a is “0.7”, the communication judger 50 determines that the degree-of-threat threshold is “0.99”. When the degree of abnormality of access from the subject terminal 12a is “0.95”, the communication judger 50 determines that the degree-of-threat threshold is “0.80”.

As discussed above, according to the threshold association information 38, a smaller degree-of-threat threshold is associated with a greater degree a of abnormality. In other words, a greater degree-of-threat threshold is associated with a smaller degree a of abnormality. Accordingly, as the degree of abnormality of access from the subject terminal 12a is greater, a smaller degree-of-threat threshold is determined. As the degree of abnormality of access from the subject terminal 12a is smaller, a greater degree-of-threat threshold is determined.

The communication judger 50 then compares the identified degree-of-threat threshold with the degree of threat of the subject host 14a obtained by the degree-of-threat obtainer 46. If the degree of threat of the subject host 14a is found to be greater than or equal to the identified degree-of-threat threshold, the communication judger 50 determines that the subject host 14a is a threat and accordingly judges that access from the subject terminal 12a to the subject host 14a is insecure communication. In contrast, if the degree of threat of the subject host 14a is found to be smaller than the identified degree-of-threat threshold, the communication judger 50 determines that the subject host 14a is not a threat and accordingly judges that access from the subject terminal 12a to the subject host 14a is not insecure communication. In this manner, the communication judger 50 judges whether the subject host 14a is a threat, based on the degree of abnormality of access from the subject terminal 12a.

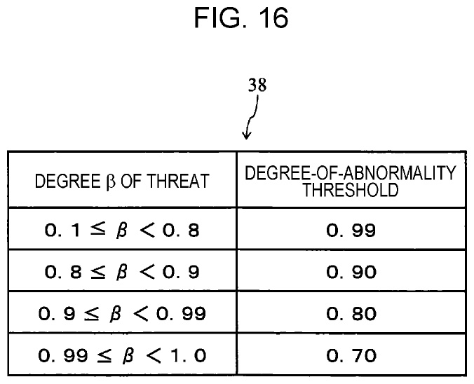

The communication judger 50 may judge whether a subject terminal 12a is infected with malware, based on the degree of threat of a subject host 14a. In this case, as the threshold association information 38, information indicating the association between the degree β of threat of the subject host 14a and a degree-of-abnormality threshold, which is the threshold regarding the abnormality of access from a terminal 12, is prepared, as shown in FIG. 16.

In this case, the communication judger 50 refers to the threshold association information 38 and identifies the degree-of-abnormality threshold associated with the degree of threat of the subject host 14a obtained by the degree-of-threat obtainer 46. According to the threshold association information 38, a smaller degree-of-abnormality threshold is associated with a greater degree β of threat. In other words, a greater degree-of-abnormality threshold is associated with a smaller degree β of threat. Accordingly, as the degree of threat of the subject host 14a is greater, a smaller degree-of-abnormality threshold is determined. As the degree of threat of the subject host 14a is smaller, a greater degree-of-abnormality threshold is determined.

The communication judger 50 then compares the identified degree-of-abnormality threshold with the degree of abnormality of access from the subject terminal 12a obtained by the degree-of-abnormality obtainer 48. If the degree of abnormality of access from the subject terminal 12a is found to be greater than or equal to the identified degree-of-abnormality threshold, the communication judger 50 determines that the subject terminal 12a is infected with malware and accordingly judges that access from the subject terminal 12a to the subject host 14a is insecure communication. In contrast, if the degree of abnormality of access from the subject terminal 12a is found to be smaller than the identified degree-of-abnormality threshold, the communication judger 50 determines that the subject terminal 12a is not infected with malware and accordingly judges that access from the subject terminal 12a to the subject host 14a is not insecure communication.

In this manner, in the exemplary embodiment, the communication judger 50 judges whether access from a subject terminal 12a to a subject host 14a is insecure communication, based on both of the degree of abnormality of access from the subject terminal 12a and the degree of threat of the subject host 14a. It may thus be determined more accurately whether access from a subject terminal 12a to a subject host 14a is insecure communication than when it is determined whether a subject terminal 12a is infected with malware only based on the degree of abnormality of the subject terminal 12a or whether a subject host 14a is a threat only based on the degree of threat of the subject host 14a.

For example, according to the exemplary embodiment, even when the degree of threat of a subject host 14a is low, if the degree of abnormality of access from a subject terminal 12a accessing the subject host 14a is high, it may be determined that the subject host 14a is a threat. That is, it may be judged that access from the subject terminal 12a to the subject host 14a is insecure communication. Additionally, even when the degree of abnormality of access from a subject terminal 12a is low, if the degree of threat of a subject host 14a to be accessed from the subject terminal 12a is high, it may be determined that the subject terminal 12a is infected with malware. That is, it may be judged that access from the subject terminal 12a to the subject host 14a is insecure communication.

The communication judger 50 executes the above-described judging processing intermittently (every several minutes, for example). If the communication judger 50 causes the first learning unit 34 to output the degree of threat of a subject host 14a and the second learning unit 36 to output the degree of abnormality of access from a subject terminal 12a every time the communication judger 50 executes judging processing, the processing load on the first and second learning units 34 and 36 or the processor 42 is increased. This issue is noticeable particularly when the security server 22 executes judging processing regarding communication between a large number of terminals 12 and hosts 14.

To deal with this issue, the degree of threat of each host 14 obtained by the degree-of-threat obtainer 46 may be retained for a predetermined time as the cache data 40 (see FIG. 6). When the degree of threat of a subject host 14a is found in the cache data 40, the communication judger 50 may execute the above-described judging processing based on the degree of threat of the subject host 14a retained as the cache data 40 without causing the degree-of-threat obtainer 46 and the first learning unit 34 to obtain the degree of threat of this subject host 14a.

The degree of abnormality of access from each terminal 12 obtained by the degree-of-abnormality obtainer 48 may be retained for a predetermined time as the cache data 40 (see FIG. 7). When the degree of abnormality of access from a subject terminal 12a is found in the cache data 40, the communication judger 50 may execute the above-described judging processing based on the degree of abnormality of access from the subject terminal 12a retained as the cache data 40 without causing the degree-of-abnormality obtainer 48 and the second learning unit 36 to obtain the degree of abnormality of access from this subject terminal 12a.

Referring back to FIG. 4, the insecure communication handling processer 52 will be explained. In response to the communication judger 50 having judged that access from a subject terminal 12a to a host terminal 14a is insecure communication, the insecure communication handling processer 52 executes various types of processing. For example, the insecure communication handling processer 52 causes the network device 16 to block access from the subject terminal 12a to the subject host 14a and also sends an instruction to output a warning to the subject terminal 12a. The insecure communication handling processer 52 may also output a notification to the administrator terminal used by the administrator of the network device 16.

While the exemplary embodiment has been discussed above, the disclosure is not restricted thereto. Various changes may be made to the exemplary embodiment without departing from the spirit and scope of the disclosure.

For example, in the exemplary embodiment, the first and second learning units 34 and 36 perform learning under the control of the learning processor 44 of the security server 22. However, another device may cause the first and second learning units 34 and 36 to perform learning, and then, the resulting first and second learning units 34 and 36 may be stored in the memory 32. Additionally, although in the exemplary embodiment the functions such as the learning processor 44, the degree-of-threat obtainer 46, the degree-of-abnormality obtainer 48, the communication judger 50, and the insecure communication handling processer 52 are integrated in the security server 22, they may be contained in the network device 16.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to judge whether access from a subject terminal to a subject host is insecure communication, based on
a degree of threat of the subject host, the degree of threat of the subject host being obtained as a result of inputting information indicating the subject host into a first learning unit, the first learning unit having performed first learning by using learning data so as to learn to output a degree of threat of a host in response to inputting of information indicating the host, information indicating a host and whether the host is a threat being used as the learning data, and
a degree of abnormality of access from the subject terminal, the degree of abnormality of access from the subject terminal being obtained as a result of inputting a communication history of the subject terminal into a second learning unit, the second learning unit having performed second learning by using a communication history of a terminal as learning data so as to learn to output a degree of abnormality of access from the terminal.

2. The information processing apparatus according to claim 1, wherein the processor is configured to judge that access from the subject terminal to the subject host is insecure communication when the degree of threat of the subject host is greater than or equal to a degree-of-threat threshold, the degree-of-threat threshold being smaller as the degree of abnormality of access from the subject terminal is greater.

3. The information processing apparatus according to claim 1, wherein the processor is configured to:
retain for a predetermined time the degree of threat of the subject host output from the first learning unit; and
intermittently judge whether access from the subject terminal to the subject host is insecure communication, based on the retained degree of threat of the subject host.

4. The information processing apparatus according to claim 2, wherein the processor is configured to:
retain for a predetermined time the degree of threat of the subject host output from the first learning unit; and
intermittently judge whether access from the subject terminal to the subject host is insecure communication, based on the retained degree of threat of the subject host.

5. The information processing apparatus according to claim 1, wherein the processor is configured to:
retain for a predetermined time the degree of abnormality of access from the subject terminal output from the second learning unit; and
intermittently judge whether access from the subject terminal to the subject host is insecure communication, based on the retained degree of abnormality of access from the subject terminal.

6. The information processing apparatus according to claim 2, wherein the processor is configured to:
retain for a predetermined time the degree of abnormality of access from the subject terminal output from the second learning unit; and
intermittently judge whether access from the subject terminal to the subject host is insecure communication, based on the retained degree of abnormality of access from the subject terminal.

7. The information processing apparatus according to claim 1, wherein:
the first learning unit performs the first learning in a supervised manner; and
the second learning unit performs the second learning in an unsupervised manner.

8. The information processing apparatus according to claim 2, wherein:
the first learning unit performs the first learning in a supervised manner; and
the second learning unit performs the second learning in an unsupervised manner.

9. The information processing apparatus according to claim 3, wherein:
the first learning unit performs the first learning in a supervised manner; and
the second learning unit performs the second learning in an unsupervised manner.

10. The information processing apparatus according to claim 4, wherein:
the first learning unit performs the first learning in a supervised manner; and
the second learning unit performs the second learning in an unsupervised manner.

11. A non-transitory computer readable medium storing a program causing a computer to execute a process, the process comprising:
judging whether access from a subject terminal to a subject host is insecure communication, based on
a degree of threat of the subject host, the degree of threat of the subject host being obtained as a result of inputting information indicating the subject host into a first learning unit, the first learning unit having performed first learning by using learning data so as to learn to output a degree of threat of a host in response to inputting of information indicating the host, information indicating a host and whether the host is a threat being used as the learning data, and
a degree of abnormality of access from the subject terminal, the degree of abnormality of access from the subject terminal being obtained as a result of inputting a communication history of the subject terminal into a second learning unit, the second learning unit having performed second learning by using a communication history of a terminal as learning data so as to learn to output a degree of abnormality of access from the terminal.

12. An information processing apparatus comprising:
judging means for judging whether access from a subject terminal to a subject host is insecure communication, based on
a degree of threat of the subject host, the degree of threat of the subject host being obtained as a result of inputting information indicating the subject host into a first learning unit, the first learning unit having performed first learning by using learning data so as to learn to output a degree of threat of a host in response to inputting of information indicating the host, information indicating a host and whether the host is a threat being used as the learning data, and
a degree of abnormality of access from the subject terminal, the degree of abnormality of access from the subject terminal being obtained as a result of inputting a communication history of the subject terminal into a second learning unit, the second learning unit having performed second learning by using a communication history of a terminal as learning data so as to learn to output a degree of abnormality of access from the terminal.
